(19) United States
(12) Patent Application Publication
(10) Pub. No.: US 2012/0220361 A1
(43) Pub. Date: Aug. 30, 2012

(54) AMUSEMENT GAMING SYSTEM

(76) Inventor: James Plescia, Sun Valley, CA (US)

(21) Appl. No.: 13/403,043

(22) Filed: Feb. 23, 2012

Related U.S. Application Data
(60) Provisional application No. 61/446,097, filed on Feb. 24, 2011.

(51) Int. Cl. A63F 13/00

(52) U.S. Cl. 463/25

(57) ABSTRACT

The present invention discloses a video amusement gaming system that rewards players with prizes, but that enables modification of a gaming system component without having to replace an existing machine or purchase of a new machine. The gaming system includes electric and electronic hardware components associated with gaming systems, a computer system, a monitor for display of a game, a control panel that resides within the computer system, and an interface control board that enables communications of a first set of signals associated with the control panel and a second set of signals associated with electric and electronic hardware components so to allow the modification of a gaming system component without having to replace an existing or purchase of a new machine.

### CROSS-REFERENCE TO RELATED APPLICATIONS

This Application claims the benefit of priority of the co-pending U.S. Provisional Utility Patent Application No. 61/446,097, filed Feb. 24, 2011, the entire disclosure of which is expressly incorporated by reference herein.

### BACKGROUND OF THE INVENTION

1. Field of the Invention

This invention is related to amusement gaming systems that rewards players based on skill and, more particularly, to skill-based amusement gaming systems that are modularized. References to a “skill” based gaming system throughout the disclosure versus “chance” based gaming systems are meant as illustrative of one exemplary embodiment and for convenience of example only. Those skilled in the art would appreciate that the present invention can easily be modified and is equally applicable to a “chance” based amusement gaming system.

2. Description of Related Art

FIG. 1A is an exemplary illustration of a typical, well-known conventional video-type skill-based amusement gaming machine that has been in use for a number of years, and FIG. 1B is an exemplary system level illustration of the gaming system components of the amusement gaming machine of FIG. 1A. Regrettably, most such conventional amusement gaming machines suffer from an obvious disadvantage in that the entire gaming systems of these machines are very tightly integrated and are permanently fixed and exclusively made for and are solely dedicated to a single game, only.

As best illustrated in FIG. 1B, the gaming systems of the gaming machines 100 illustrated in FIG. 1A may be broadly divided into three basic blocks of Electric/Hardware Components 102, Gaming Control Board 104, and a display 106 such as a Liquid Crystal Display (LCD). Non-limiting, non-exhaustive listing of Electric/Hardware Components 102 may include a cabinet structure that accommodates or houses the entire gaming system, the accompanied theme of the game (also as part of the Electric/Hardware Components), for example, audio (e.g., game speakers, sounds or music) and visual (e.g., color, lights, marquee, artwork, advertisements, etc.), or other stimulus elements associated with the game that provide the “look and feel” that is commonly identified with the game. Other tightly integrated gaming system components may include a user gaming control console (also as part of the Electric/Hardware Components 102 of FIG. 1B) that includes various user input devices such as buttons, a joystick, etc., electromechanical components that include electric motors to actuate prize dispensers, and so on. Non-limiting, non-exhaustive listing of elements of a Gaming Control Board 104 may include electronics and firmware that drive the electromechanical components and receive input signals from user input devices, with the electronics included on a dedicated gaming control board. Regrettably, since most of the gaming system components of the conventional amusement gaming system are tightly integrated and substantially permanently fixed, and exclusively made for and solely dedicated to a single game only, no aspect of any one or more gaming system components can be modified without substantially modifying other system components.

A non-limiting example of a tight integration of gaming system components is the conventional gaming control board 104, which manages all input and output signals for control of hardware and execution of firmware. This includes input signals from various input devices (e.g., joystick, buttons, etc.) and control output signals to output devices such as the LCD video monitor, the prize dispensers (that are electromechanical devices using motors), lighting, etc. The gaming control board further includes rudimentary firmware related software for providing scores of the game, winnings, determinations as to which score wins which prize, and which of the prize dispensers to activate for that winning with the particular score and prize and so on. The firmware, as with most other elements of the conventional amusement gaming system 100, is very tightly integrated and exclusively made for and solely dedicated to a single game only.

In general, most conventional gaming control boards 104 use an Integrated Circuit (IC) Electrically Erasable Programmable Read-Only Memory (EEPROM) chip that retains the firmware that controls prize dispensers, and if, for example, the score to win a particular prize is desired to be modified (e.g., made higher), then the EEPROM must be reprogrammed. That is, the EEPROM IC chip on the gaming control board 104 must be removed and replaced with a new EEPROM IC chip that includes the updated firmware for controlling the prize dispensers in relation to the new scoring and winning scheme. It is needless to state that the obvious disadvantage is that upgrading or modifying an EEPROM IC chip takes time, and is costly in terms of parts and labor requiring fairly high skilled man-power for removal of the older IC from the gaming control board, and replacement thereof by a new IC that has been reprogrammed by a manufacturer that has to ship the IC to the consumer.

Accordingly, due to the tight, permanently fixed integration of the gaming system components, it is difficult (if not impossible) to modify any aspect of a conventional amusement gaming machine 100, including changing the game. Given that the modification of any aspect of the gaming system components is very difficult, one drawback with the conventional amusement gaming machine 100 is that users are compelled to play the same game over and over, only to loose interest in the game after a short period. Since most conventional amusement gaming machines 100 are coin-operated and owned by business to generate revenue, once players loose interest in the game, the revenue generated by the gaming system is substantially reduced. As illustrated in FIG. 1A, conventional amusement gaming machines 100 are also very bulky and costly. Accordingly, for most businesses with very limited floor-space, the only choice of ordering another amusement gaming machine 100 for a new resurgence of income would most likely not be an option.

Another major drawback with conventional video-type amusement gaming machines 100 that use a video game monitor (such as a Liquid Crystal Display (LCD)) is that they present the games displayed on the monitor in a manner that makes it very obvious that the game being played is a video game on an LCD. A point of concern for most conventional video-type amusement gaming system is “believability” in winning a game. That is, for most users, the perceived “winnability” of a video game is very low, which negatively affect revenues generated by the gaming system for the business owner. For example, it has been found that in most instances, players perceive a mechanical based gaming machine of a game as more winnable than an electronic version of the same exact game with substantially identical controls and skills required for winning the game to win prizes. A cause for this may be that the users are of a belief that since the non-mechanical version of the game is software based, the software can much more easily be manipulated to a point where the game is less winnable compared to the mechanical version of the same game. In other words, the mechanical version of the game might be perceived as more “honest,” and hence, more winnable than its electronic version. Although this perception is false, nonetheless, the perceived lower “winnability” of a conventional video-type amusement gaming machine does negatively affect revenues.

Accordingly, in light of the current state of the art and the drawbacks to current amusement gaming systems mentioned above (skilled or chance based), a need exists for a video-type skill/chance-based amusement gaming system that would enable modification of a gaming system component without having to replace an existing or purchase of a new machine. Additionally, a need exists for a video-type skill/chance-based amusement gaming system that would improve user experience in terms of improved “winnability” perception of the game.

### BRIEF SUMMARY OF THE INVENTION

A non-limiting, exemplary optional aspect of the present invention provides a video amusement gaming system that rewards players with prizes, comprising:

electric and electronic hardware components;

a computer system;

a monitor for display of a game;

control panel to configure settings for the amusement gaming system;

an interface control board that enables communications of a first set of signals associated with the control panel with the computer system and a second set of signals associated with electric and electronic hardware components.

Another non-limiting, exemplary optional aspect of the present invention provides a video amusement gaming system that rewards players with prizes, comprising a cabinet that houses the video amusement gaming system, including electric and electronic hardware components;

a monitor;

a single board computer system with associated input and output devices for installing a game for display on the monitor and configuring control signals associated with the game; and

an interface control board that communicates a first set of signals associated with the single board computer systems with electric and electronic hardware components that are associated with a second set of signals.

Still another non-limiting, exemplary optional aspect of the present invention provides a video amusement gaming system that rewards players with prizes, comprising

an enclosed cabinet with a single ingress and egress access into and out of an interior of the cabinet, having a fully, permanently closed back wall and a single door that opens from a front of the cabinet that has a height substantially commensurate with a height of the cabinet to enable secure access for easy installation, repair, and maintenance of system components in the interior of the cabinet;

theme accommodating structures associated with the cabinet to detachably house interchangeable and exchangeable removable themes associated with a particular game;

inconspicuous daisy chained wiring system that daisy chains all electrical system components together by an electrical wire that provides power and control signals to system components, and is accessible from a front interior of the cabinet;

electric and electronic hardware components;

a monitor;

a single board computer system with associated input and output devices for installing the game and associated control signals;

an interface control board that communicates a first set of signals associated with the single board computer systems with electric and electronic hardware components that are associated with a second set of signals.

Yet another non-limiting, exemplary optional aspect of the present invention provides a video amusement gaming system that rewards players with prizes, wherein:

the monitor is covered by an overlay mask for providing context for and meaning to a game, including providing simulation of Light Emitting Diode based gaming system.

A further non-limiting, exemplary optional aspect of the present invention provides a computer program product for a video amusement gaming system, the computer program product comprising a computer-readable medium having computer program instructions stored therein for causing one or more computers to perform operations of:

providing user interface control panel on a display screen to configure settings for the amusement gaming system, including:

a first control panel that includes:

modules for setting motor actuation states, skill level states, game play time, and required coins per play;

a second control panel that includes:

output setting modules for setting states of output devices; and

input setting module for setting and determining actuation of input devices;

an event log module that determines time, day, and dispenser number with respect to a legitimate winning or malfunction.

Such stated advantages of the invention are only examples and should not be construed as limiting the present invention. These and other features, aspects, and advantages of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” is used exclusively to mean “serving as an example, instance, or illustration.” Any embodiment described as “exemplary” is not necessarily to be construed as preferred or advantageous over other embodiments.

Referring to the drawings in which like reference character(s) present corresponding part(s) throughout:

FIG. 1A is an exemplary illustration of a typical, conventional video-type skill-based amusement gaming machine, and FIG. 1B is an exemplary system level illustration of the gaming system components of the amusement gaming machine of FIG. 1A;

FIG. 2A is a non-limiting, exemplary perspective illustration of a video-type amusement gaming system in accordance with the present invention, and FIG. 2B is a plan view of the same;

FIGS. 2C to 2E are non-limiting, exemplary illustrations of the various views of amusing gaming machine illustrated in FIGS. 2A and 2B in accordance with the present invention;

FIGS. 3A to 3F are non-limiting, exemplary illustrations of the amusement gaming machine of FIGS. 2A to 2E with an installed first game in accordance with the present invention, and FIGS. 3G to 3L are non-limiting, exemplary illustrations of the same amusement gaming machine of FIGS. 2A to 2E, but with a completely different installed game in accordance with the present invention;

FIG. 4 is a non-limiting, exemplary systems level block diagram of the amusement gaming system in accordance with the present invention;

FIG. 5 is a non-limiting, exemplary block illustration of an interface control board in accordance with the present invention; and

FIGS. 6A to 6F are non-limiting, exemplary Graphic User Interface (GUI) screen shots of software based control panel in accordance with the present invention.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

For purposes of illustration, programs and other executable program components are illustrated herein as discrete blocks, although it is recognized that such programs and components may reside at various times in different storage components, and are executed by the data processor(s) of the computers. Further, each block within a flowchart (if a flowchart is used) may represent both, method function(s), operation(s), or act(s) and one or more elements for performing the method function(s), operation(s), or act(s). In addition, depending upon the implementation, the corresponding one or more elements may be configured in hardware, software, firmware, or combinations thereof.

The present invention provides an amusement gaming system that includes various gaming system components that are modularized for independent modification, interchangeability, and exchangeability. That is, the present invention provides a video-type amusement gaming system that would enable modification of a gaming system component of a gaming machine without replacement or purchase of a new gaming machine. In other words, the video-type amusement gaming system of the present invention enables a complete change of venue in terms of game, theme, and any other related aspect associated with a particular game quickly and at low cost for resurgence of income for owners of such gaming machines. Additionally, the present invention provides a video-type amusement gaming system that improves user experience in terms of improved “winnability” perception of the game.

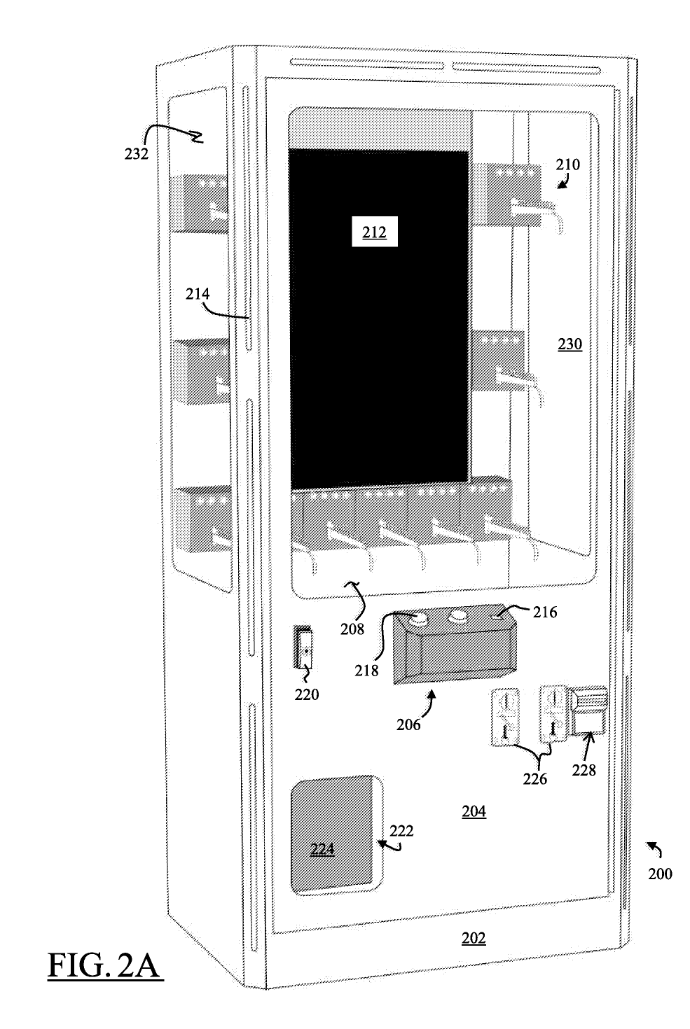

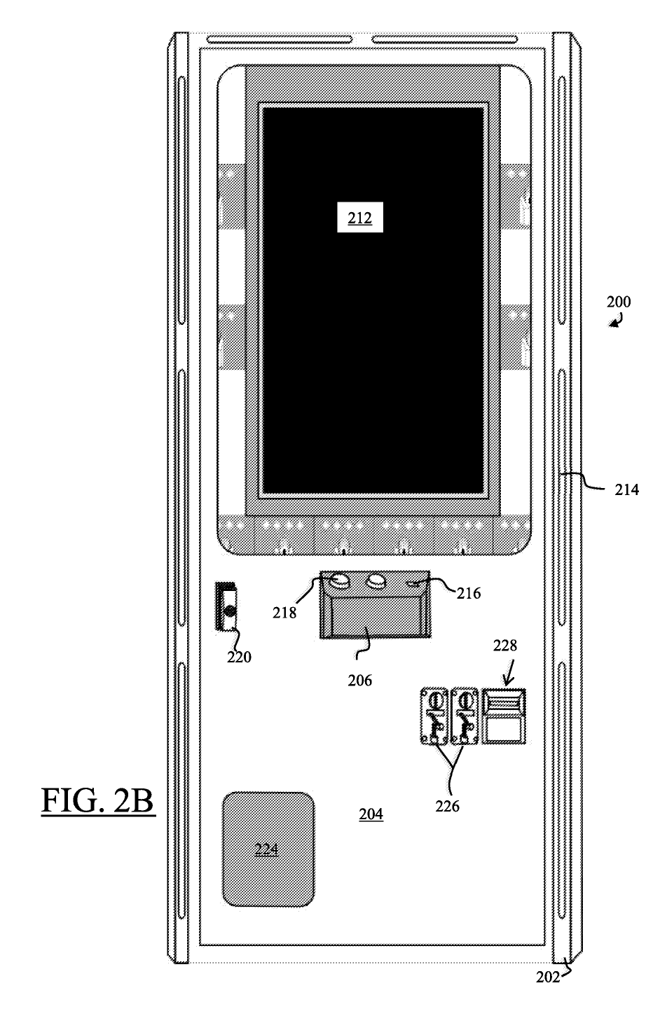

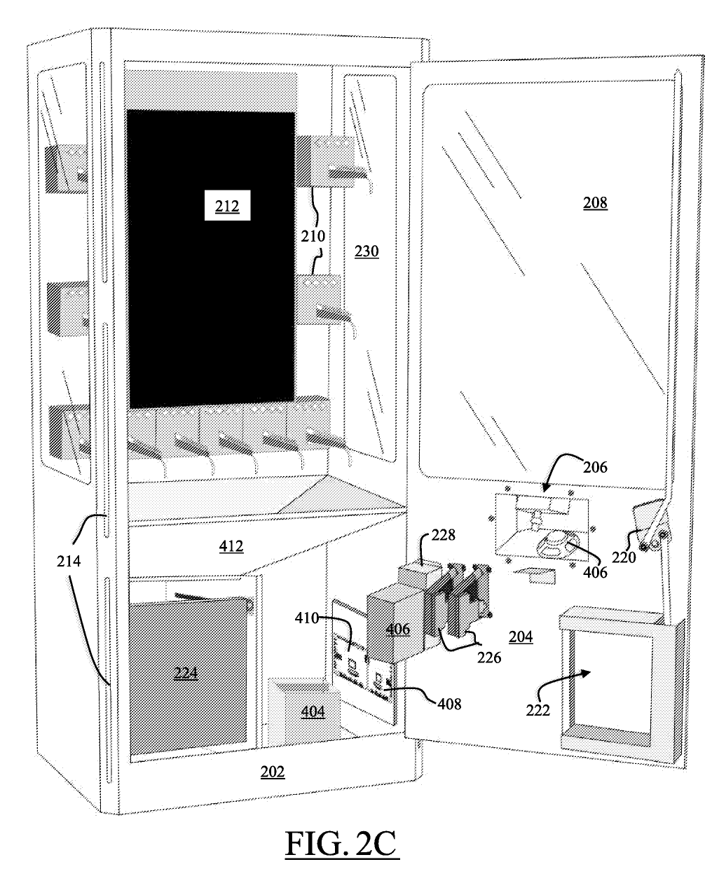

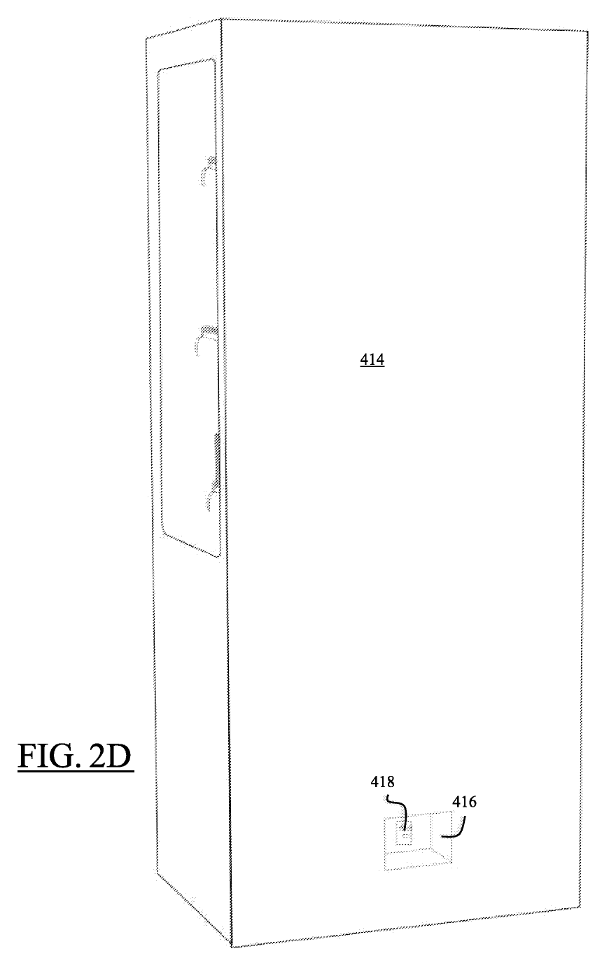

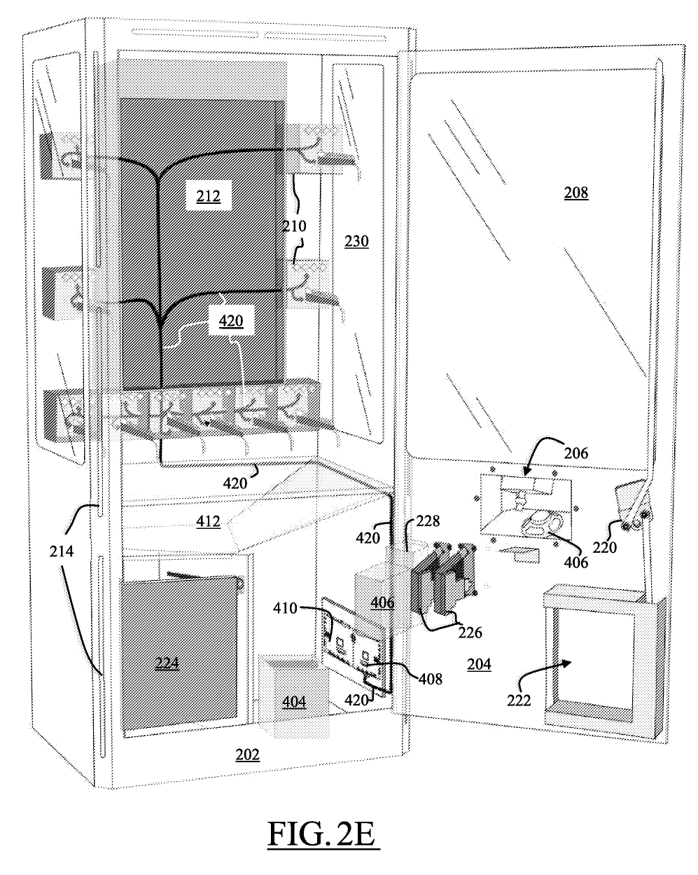

FIG. 2A is an exemplary perspective illustration of a video-type amusement gaming system in accordance with the present invention, and FIG. 2B is a plan view of the same. The amusement gaming machine 200 of the present invention illustrated in FIGS. 2A and 2B includes a generic, basic “skeletal” machine that is ready for quick installment of a game and its associated theme. In other words the video-type amusement gaming machine 200 of the present invention enables a complete, quick change of venue in terms of game, theme, and any other related aspect associated with a particular game quickly and at a very low cost, but without having to replace or purchase a completely new machine.

As illustrated, from the exterior, the amusement gaming machine 200 of the present invention provides a gaming system that has a cabinet structure 202 with one or more theme accommodating structures that without use of any tools detachably house interchangeable and exchangeable removable themes associated with any particular game. The theme accommodating structures may be provided at any desired strategic location within and or outside the cabinet 202 to enable addition of theme elements, non-limiting examples of which may include artwork, banners, marquees or any other visual stimuli (including advertisements) to conspicuously show and provide a “look and feel” that is associate with the accompanying game. It should be noted that owners of such machines may also provide their own theme elements that provides the “look and feel” of the establishment that has purchased the gaming system 200 of the present invention. Regardless, changes of theme elements are great “eye catching” stimuli that function to attract and inform players about a new game, but without the owners having to purchase and install an entirely new machine.

Theme accommodating structures enables end users (e.g., owners of the machine) to detachably secure and change a banner or marquee associated with one game for another quickly and easily, for example, removing all banner/marquee associated with a “tic-tac-toe” game and replacing them with a “Drag Star” game themes. The theme elements may be detachably secured with the cabinet structures by theme accommodating structure by a plethora of methods, a non-limiting, non-exhaustive listing example of which may include the use of frame structures comprised of periphery flanges around any section of the cabinet that form into a frame or a frame structure, with the theme elements inserted within the frame. Other non-limiting examples of theme accommodating structure may include the use of various detachable fasteners, including complementary or reciprocal male and or female couplers, with the female coupler attached to one (e.g., the structure) and the male coupler to the other (e.g., the theme element, for example a marquee). The exemplary male coupler may be a snap-on device, with the female coupler being a joint for receiving the male coupler. It should be readily apparent to those skilled in the art that other theme accommodating structure configurations are also possible, non-limiting examples of which may include the use of snap-on elements, clips, Velcro, and so on. Therefore, the present invention provides theme elements that are removable and can be detachably fastened or mounted onto the cabinet by theme accommodating structures without the use of tools.

As further illustrated in FIGS. 2A and 2B, the amusement gaming machine 200 of the present invention includes a single front door 204 (with no detachable theme shown for clarity) that accommodates a gaming control console 206, coin and bill acceptors 226 and 228, respectively, and a prize collection access opening 222 that is blocked by a prize retrieval door 224. The prize retrieval door 224 is comprised of metallic alloy, and is associated with a set of neoprene bumpers for limiting access to the interior of the cabinet, while allowing easy retrieval of a dispensed prize. The front door 204 may be locked by any conventional lock mechanism such as the illustrated door lock mechanism 220, and further includes a large front window 208, enabling a view of the LCD 212 and two lateral windows 230 and 232 that enable full view of the various game dispensers 210. The amusement gaming machine 200 of the present invention also provides various exemplary slots 214 for lighting and esthetics. That is, the cabinet 202 facilitates the use of low voltage, rectangular rope lighting that is extended through cabinet slots 214 along one or more corners of the cabinet 202 for esthetics.

FIGS. 2C to 2E are exemplary illustrations of the various views of amusing gaming machine 200 illustrated in FIGS. 2A and 2B in accordance with the present invention, with FIG. 2C illustrating the same with front door 204 open, FIG. 2D illustrating the back side 414, and FIG. 2E illustrating the internal electrical wiring in relation to the dispensers 210 and other electrical and electronic equipment.

As illustrated, the front door 204 of the cabinet 202 is a single door opening that has a three point locking system 220, with the door 204 having a height substantially commensurate with a height of the cabinet 202. The single large front door 204 enables secure access for easy installation, repair, and maintenance of various system components in the interior of the cabinet 202. Non-limiting, non-exhaustive listing of various gaming system components housed in the interior of the cabinet 202 may include the coin and bill acceptors 228 and 226, the coin collection “bucket” 404, an enlarged bill-collection box 406, the prize shoot 412, a Single Board Computer (SBC) 410, an Interface Control Board (ICB) 408, internal power wiring 420, dispensers 210, lighting 211 associated with dispensers, and so on.

The present invention uses square tubing as reinforcement to improve the structural integrity of the door to strengthen the front door 204. Because the door 204 is larger, it opens wider, which enables the use of a larger capacity bill acceptor box 408, which means less frequent service call visits to empty the bill acceptor box 408 and remove collected bills. It should also be noted that the present invention also provides for a wider, larger prize shoot 412 with a larger area to allow larger prizes to fall through the shoot 412 without being obstructed. As illustrated, one advantage of a wider, larger front door 204 is an ease of access to serviceable components such as the SBC 410 and ICB 408 (electronics, programming modules, etc.). That is, with a larger door 204, there is plenty of ease of accessibility to critical components for purposes of reprogramming or troubleshooting.

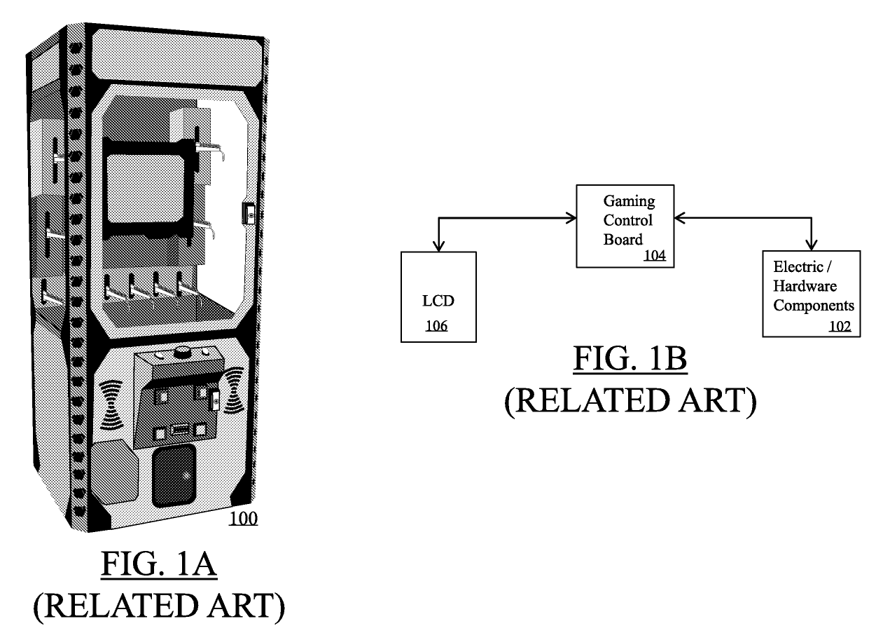

It should also be noted that since with the amusement gaming system of the present invention an owner need not replace the entire machine for a new game, the cabinet 202 of the machine would most likely be used for a long time. Accordingly, the present invention provides a cabinet 202 that is constructed with a durable material, non-limiting example of which may include steel. The conventional cabinets for the conventional gaming systems (shown in FIG. 1A) are mostly made out of materials that are not very durable (e.g., wood or pressed wood with permanently printed themes), which deteriorate very quickly. In general, an unsightly broken cabinet is a cause of reduction in revenues to be generated. Most individuals are drawn to gaming systems with esthetically pleasing cabinet structures. Accordingly, the present invention provides a cabinet structure 202 made from durable material since it need not be replaced for a new game, and will be used for different games for a longer duration.

As further illustrated, the gaming control console 206 includes the various input and output devices such as various buttons and a joystick that enables the execution of the game by a player, and output devices such as speaker 406 and a display 216 (best illustrated in FIG. 2A). The present invention provides a gaming control console 206 that has a laminated overlay adhered to a removable (or detachably secured) acrylic artwork underneath by a set of tamper proof fasteners, non-limiting examples of which may include a set of screws. The laminated overlay protects the acrylic artwork underneath. The artwork is comprised of pebble finish polycarbonate overlay. Most conventional control panels have printed matter (such as the name of the game, a character associated with the game (e.g., picture of a Pac Man, etc.) that is generally comprised of acrylic, which is very problematic because it is not durable and deteriorates quickly due in part to defacing by the players. Accordingly, the present invention provides the laminated overlay to protect the acrylic artwork underneath.

As further illustrated in FIG. 2D, the present invention provides a cabinet structure 202 with a fully enclosed back wall 414, with an opening 416 for an electrical connection (prongs 418) for connection to a power supply outlet. With most conventional amusement gaming machines, the cabinet structures have a rear panel access door that enables service personal access to the electronic wiring and control of the entire system for servicing or troubleshooting. This requires opening up the cabinet from the back panel (unloosening of screws) to access the wiring that supply power and control signals to dispensers, lights, the monitor, etc. This conventional scheme creates the inconvenience of having to pull the unit away from a wall to which the unit is placed against, and removing the large access panel (unscrewing a few screw fasteners) to access the back-end components and wiring. It should be noted that having a removable back access panel also compromises security for the machine. Therefore, as stated above, the cabinet structure 202 of the present invention has eliminated the back access panel, but instead, made the front door 204 of the cabinet as a single, larger front door to enable full access to all equipment and wirings from the front.

As best illustrated in FIGS. 2E, the present invention includes an inconspicuous daisy chained wiring scheme wherein all electrical equipment are daisy chained together by an electrical power supply wire 420 that provides power to the various equipment, including supply of power and control signals to dispensers, lights, the monitor, etc. The daisy chain wiring scheme 420 is easily accessible from the front interior of the cabinet 202, but is hidden behind the display 212, dispensers 210, and the prize shoot 412, and cannot be seen by players. The use of wiring scheme 420 in combination with a larger front door 204 eliminates the need to access the dispensers via a rear of the cabinet structure.

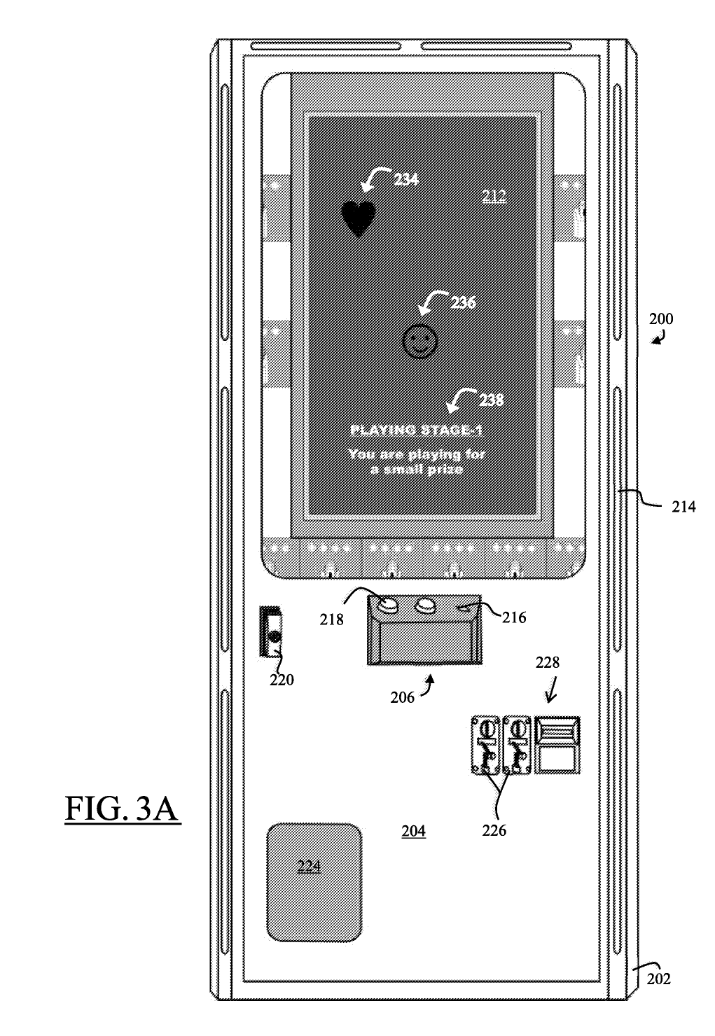

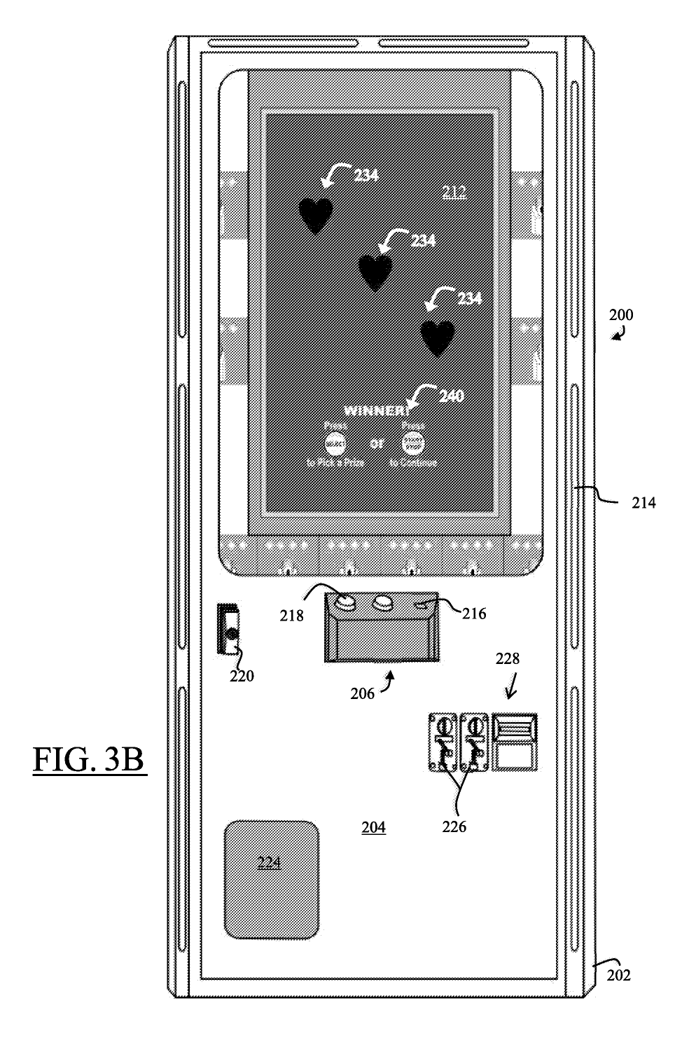

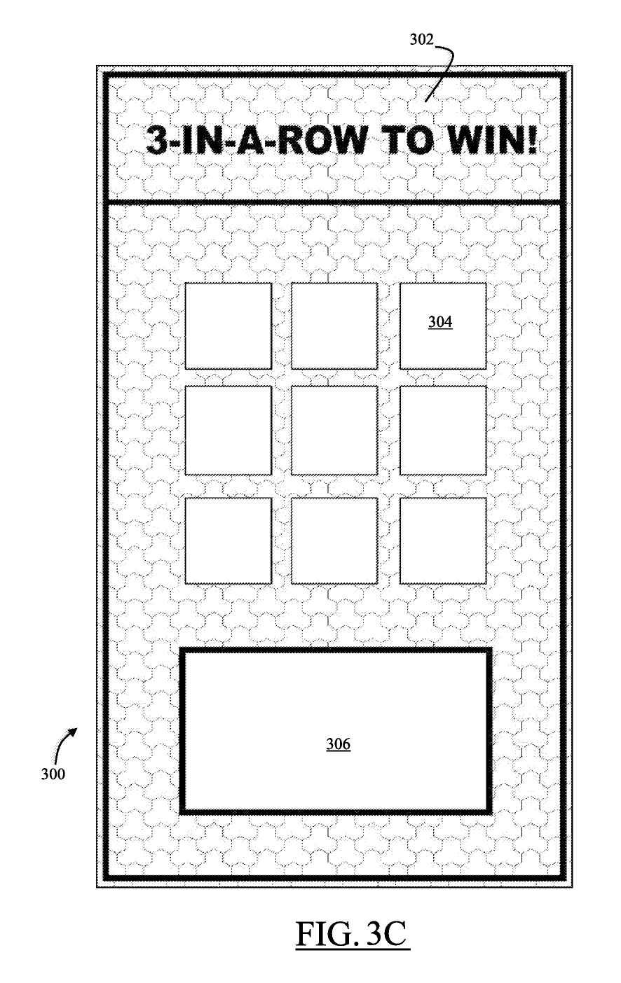

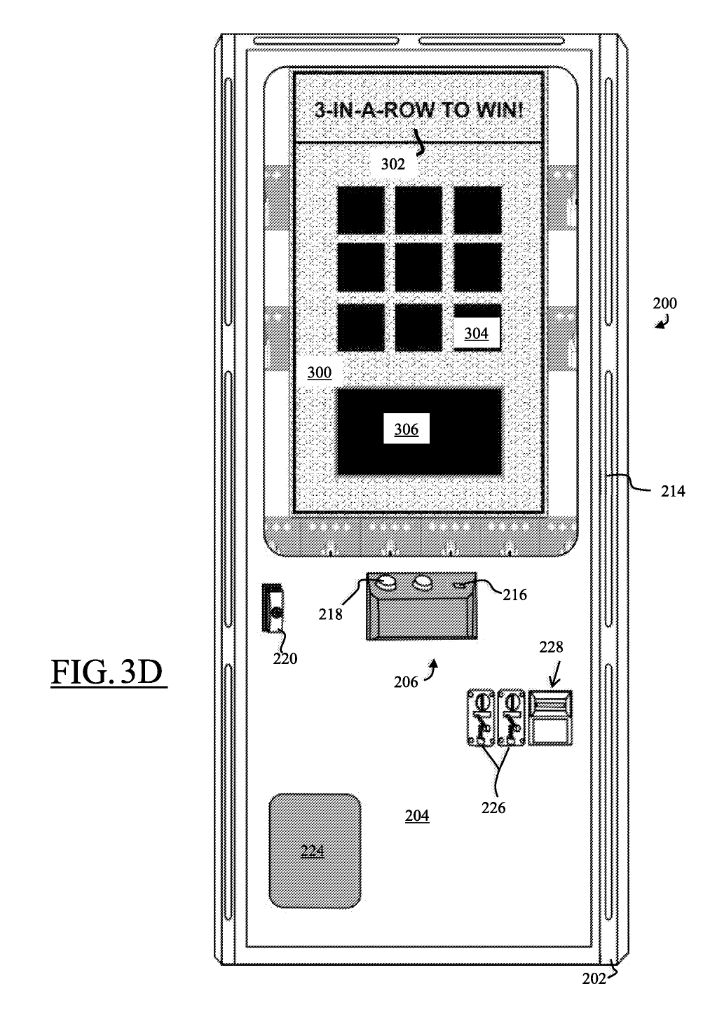

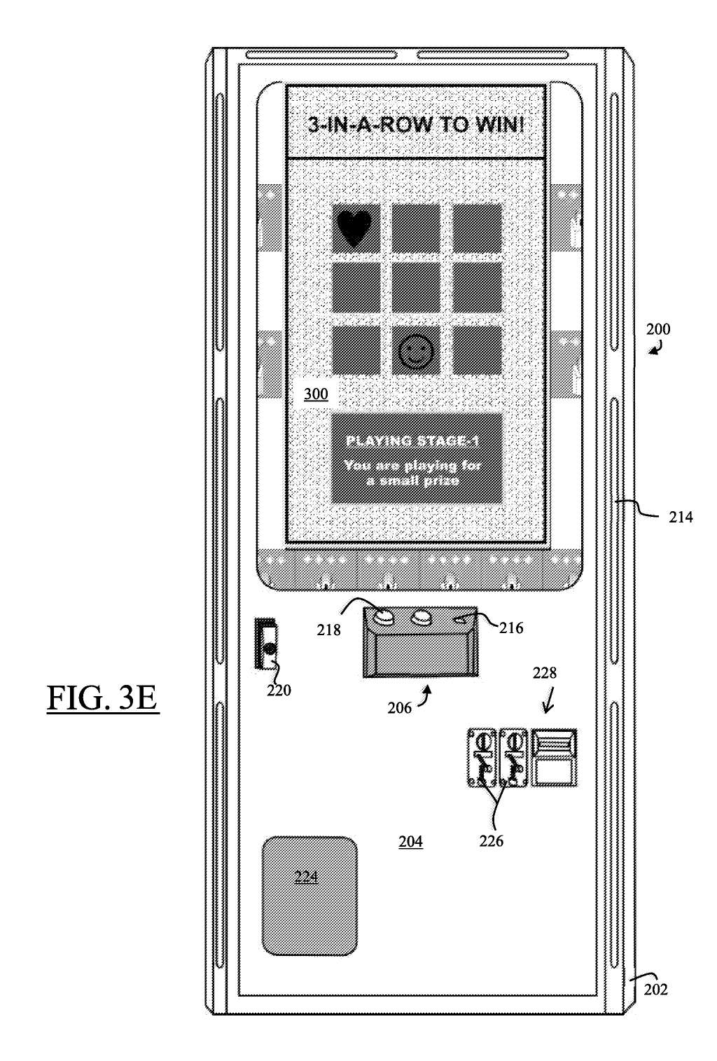

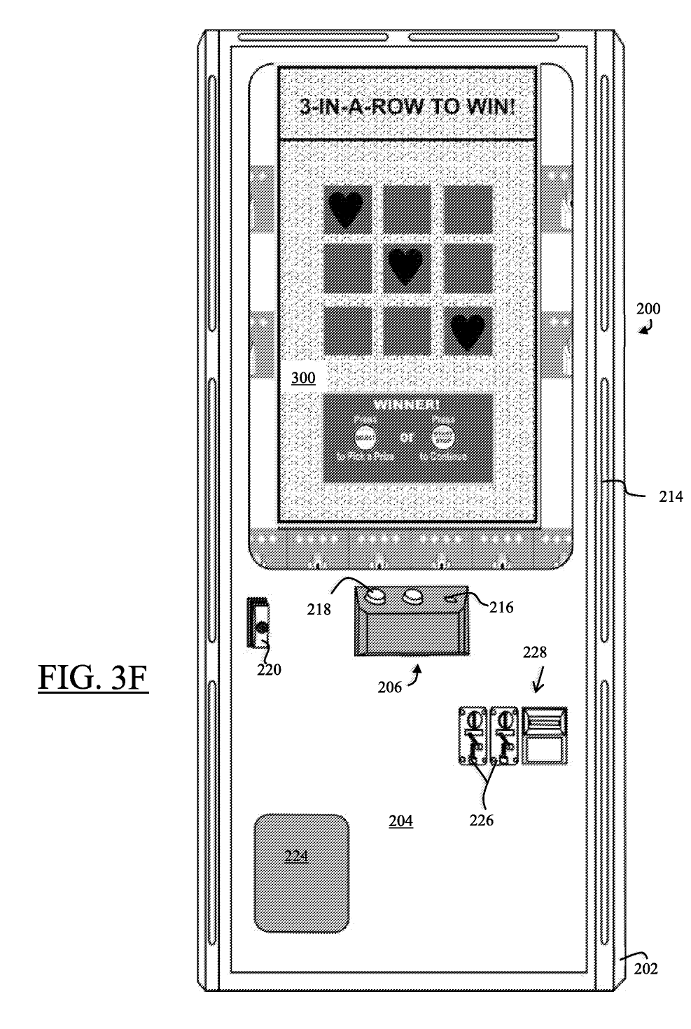

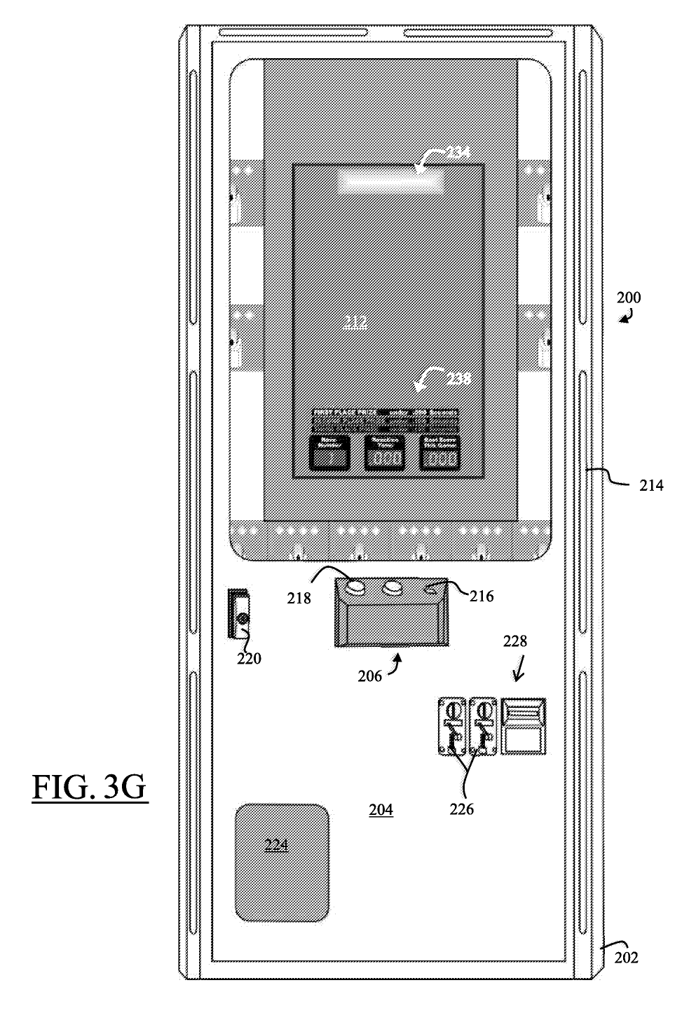

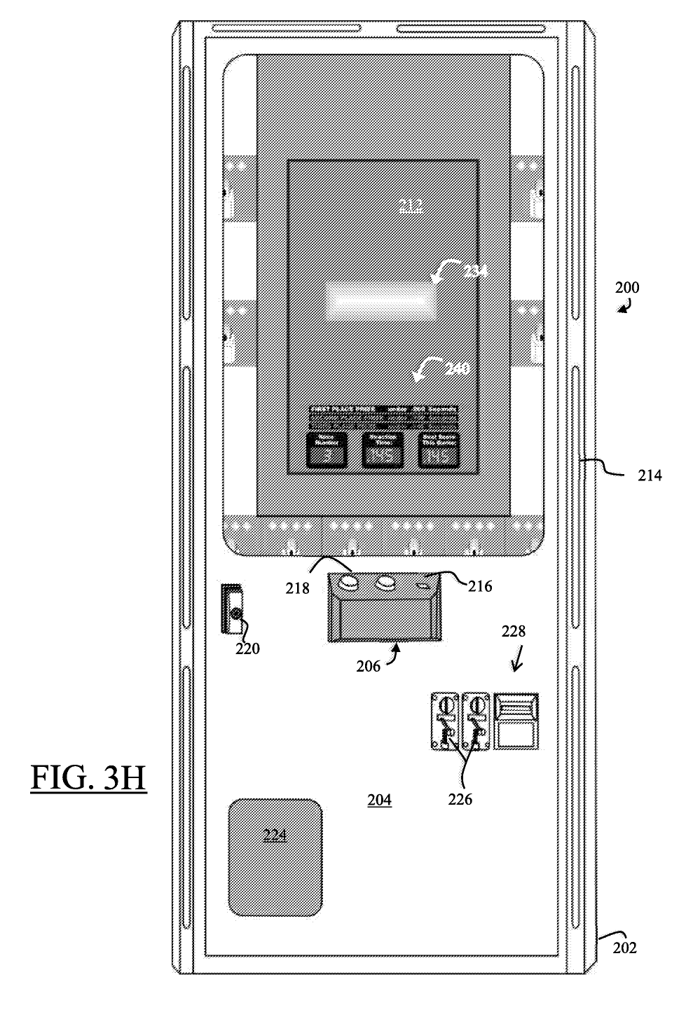

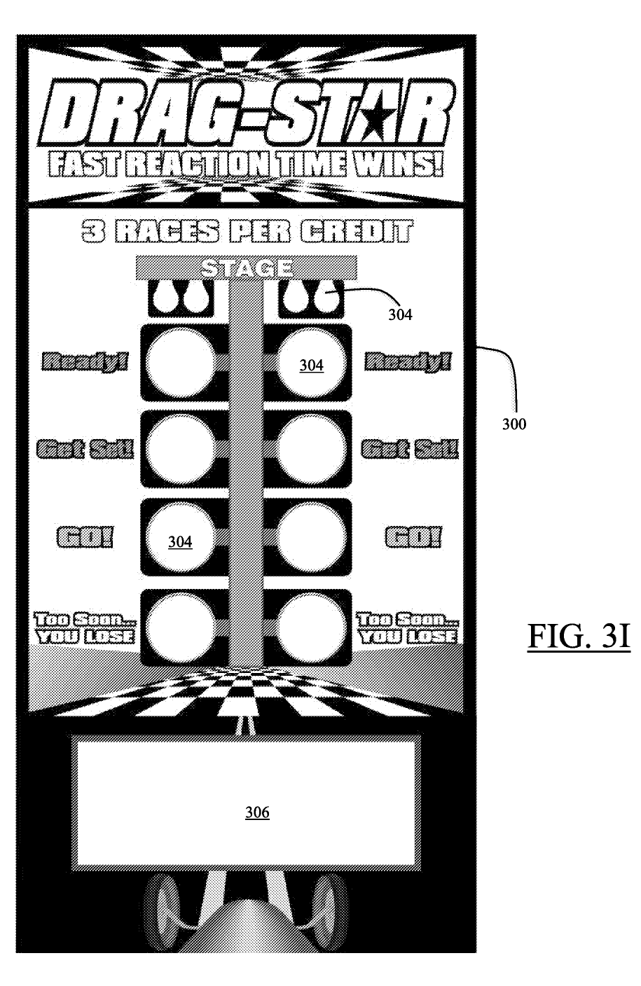

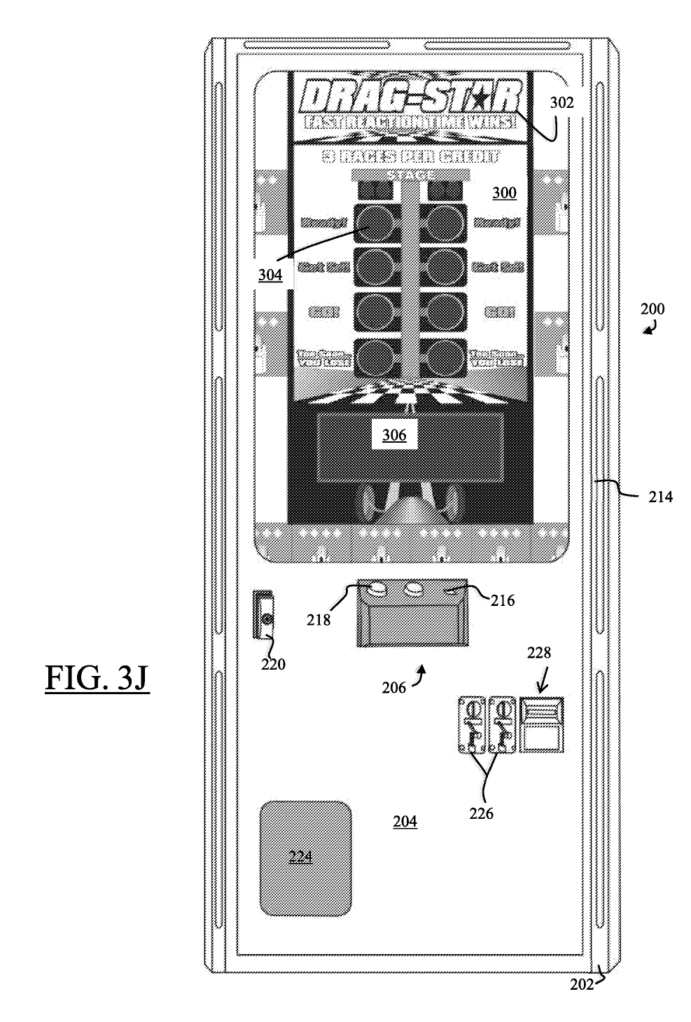

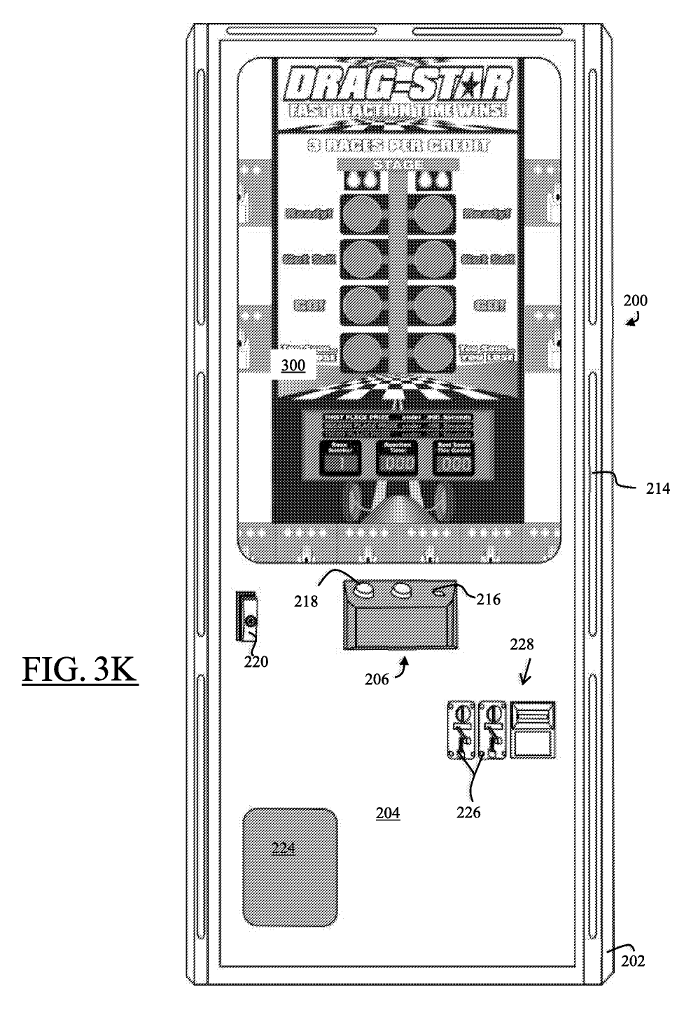

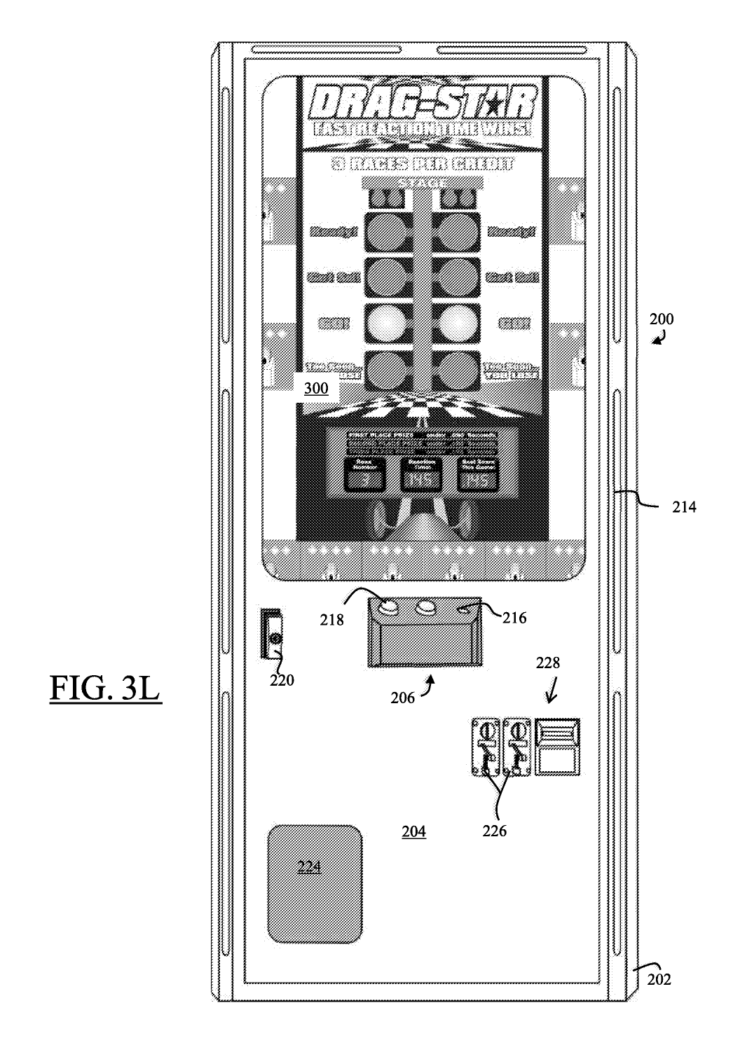

FIGS. 3A to 3F are exemplary illustrations of the amusement gaming machine 200 of FIGS. 2A to 2E, with an installed first game, and FIGS. 3G to 3L are exemplary illustrations of the same amusement gaming machine 200 of FIGS. 2A to 2E, but with a completely different installed game. Accordingly, the video-type amusement gaming system 200 of the present invention enables a complete, quick change of venue in terms of game, theme, and any other related aspect associated with a particular game quickly and at a very low cost, but without having to replace or purchase a completely new machine for a new game. An end user may purchase and install any desired game, including purchasing all theme elements associated with the game and interchangeably exchange and use them on the same exact amusement gaming machine 200 of the present invention, without having to replace or purchase a new machine.

As illustrated in FIGS. 3A to 3F, in this non-limiting exemplar instance, the amusement gaming machine 200 includes a non-limiting exemplary first game that is displayed on the LCD 212, and FIGS. 3G to 3L exemplarily illustrate a non-limiting exemplary second game that is displayed on the LCD 212. Since the games are completely different, they require different themes, different input/output control signals to operate various gaming system components such as the control of dispensers 210, prize winnings, lights, and etc. on the same machine 200. In other words, those skilled in the art would appreciate that the present invention is not a mere uploading and replacement of one game for anther. For example, the first game illustrated in FIGS. 3A to 3F may require signals from only one input device (e.g., only one of the buttons 218 on the gaming control console 206 may be required by the game to be actuated by a player), and have control output signals to output devices such as the LCD video monitor, which would obviously be different from the second game (illustrated in FIGS. 3G to 3L). On the other hand, the second game (shown in FIGS. 3G to 3L) may require the use of both buttons 218 on the gaming control console 206, where the game would require a player to manipulate both buttons 218. As another example, the prize dispensers 210 (that are electromechanical devices using motors), and associated lighting 211, gaming sounds, actual prize winnings, and etc. may be controlled differently to dispense different prizes for the first game as compared with the second game. As a further example, the display scores of one game, the winnings for that particular game, and determinations as to which score from which game wins which prize (based on the game), and which of the prize dispensers to activate for that winning with the particular score and prize in relation to a particular game and so on must also be considered when changing games. Accordingly, those skilled in the art would greatly appreciate that the present invention enables change of one game for another, including mechanisms to fully control the entire amusement gaming system machine components commensurate with any game change and user (owner) requirement without having to purchase an entirely new machine. Therefore, the present invention provides an amusement gaming machine 200 that includes various gaming system components that are modularized for independent modification, interchangeability, and exchangeability.

FIG. 3A is an exemplary illustration of the amusement gaming system 200, showing the start of the first game (with no detachable associated theme elements shown for clarity), and FIG. 3B is an exemplary illustration of the same, but showing the end of the first game (again, with no theme elements shown for clarity). As illustrated, the amusement gaming system 200 is modularized to a point where even if the games are turned-ON and active, they are not recognized until as illustrated in FIG. 3C, a game overlay mask 300 is placed adjacent (or onto) the LCD 212 (best illustrated in FIG. 3D). The game overlay mask 300 (as best illustrated in FIGS. 3E and 3F) provides context for and meaning to the first game illustrated in FIGS. 3A and 3B, which, in this non-limiting exemplary instance is a “3-IN-A-ROW” game.

FIG. 3G is an exemplary illustration of the amusement gaming system 200, showing the start of the second game (again, with no detachable associated theme elements shown for clarity), and FIG. 3H is an exemplary illustration of the same, but showing the end of the second game (with no associated theme elements shown for clarity). As with the first game, as illustrated in FIG. 3I, when purchasing a second game, a second game overlay mask 300 (with different art work from the first game overlay mask 300) for the second game is provided, which as stated above (and as best illustrated in FIGS. 3K and 3L) provides context for and meaning to the second game illustrated in FIGS. 3G and 3H, which, in this non-limiting exemplary instance is a “RACE” game that determines reaction time of a user.

As illustrated in FIGS. 2A to 3L, all displayed content or information by the software game is made to emulate and have the look and feel of an “analog” game that displays characters, lights, scores or any other content or information under the control of the software game on the LCD 212 as if they are illuminated by Light Emitting Diode (LED) lights. The exemplary “heart” or “rectangular light” character 234, the “Smiley Face” 236, or any other content 238 is emulated and displayed by the LCD screen 212 as if they are lighted by a set of LEDs. The LED like generated characters may be generated by a variety of well-known mechanism such as animation software or Adobe Flash. The game overlay mask 300 is made with artwork so that it further reinforces the “look and feel” of a manual or analog, rather than software based gaming system. The scheme presented by the present invention provides the perception of an “old fashion” light box, manual game with LEDs with hardwired electronics and no software.

The game overlay mask 300 is coupled with the monitor screen creating a play board for the game, thereby masking the LCD screen from players to further reinforce the perception of a manual, rather than a software based game, with the monitor generating and displaying simulated Light Emitting Diode characters through mask apertures 304 and 306 that provide meaning and context for the game. In general, the game overlay mask 300 is comprised of acrylic with a polycarbonate overlay, with the mask designed to provide context and meaning to that which is displayed by the LCD.

As an example, as illustrated in FIGS. 3A to 3F, if the game is a 3-IN-A-ROW, the mask 300 of FIG. 3C for that game will include 3-IN-A-ROW grids, with apertures 304 for view of characters (heart 234, smiley face 236, etc.) through the apertures 304 shown on the LCD, including, for example, aperture 306 to allow viewing of score, the winnings, etc. Therefore, the use of the mask 300 provides meaning and context for the entire game and the characters (heart 234, smiley face 236, etc.) viewed through the mask openings. Accordingly, FIGS. 3A and 3B are non-limiting exemplary illustrations of the game during play without the mask, which is perceived as showing random characters without any meaning, and FIGS. 3E and 3F are the same stages of the same game during play shown in respective FIGS. 3A and 3B, but with the mask, which provides full context to that which is displayed on the LCD screen. FIG. 3D is the same game with the mask, but the machine is illustrated as OFF.

As another example, as illustrated in FIGS. 3G to 3L, if the game is RACE, the mask 300 of FIG. 3I for that game will include apertures 304 configured in the form of a drag-race lighting for view of characters (e.g., a simple rectangular light 234, etc.) through the apertures 304 shown on the LCD, including, for example, aperture 306 to view score, the winnings, etc. Therefore, the mask 300 provides meaning and context for the entire game and the characters (e.g., rectangular light 234) viewed through the mask openings, which are perceived as active drag-race lighting system. Accordingly, FIGS. 3G and 3H are non-limiting exemplary illustrations of the game during play without the mask, showing the vertical movement of the rectangular light 234 form top to the bottom of the screen during the game, which is perceived as random and without any meaning, and FIGS. 3K and 3L are at the same stages of the same game during play shown in respective FIGS. 3G and 3H, but with the mask, which provides context to that which is displayed on the LCD screen, which in this instance, is a mere rectangular light 234, perceived by the player as dynamically moving light of a drag-race lighting system. FIG. 3J is the same game with the mask, but the machine is illustrated as OFF.

It should be noted that as the game changes for the gaming machine 200, so does every aspect associate with that game, non-limiting examples of which include themes, controls signals for dispensers, lights, sound, prize winnings to be dispensed based on winnings, difficulty level, etc. Accordingly, the present invention provides the means (or the tools) for accommodating a change of the game and all aspects associated with the game but without having to purchase an entirely new machine.

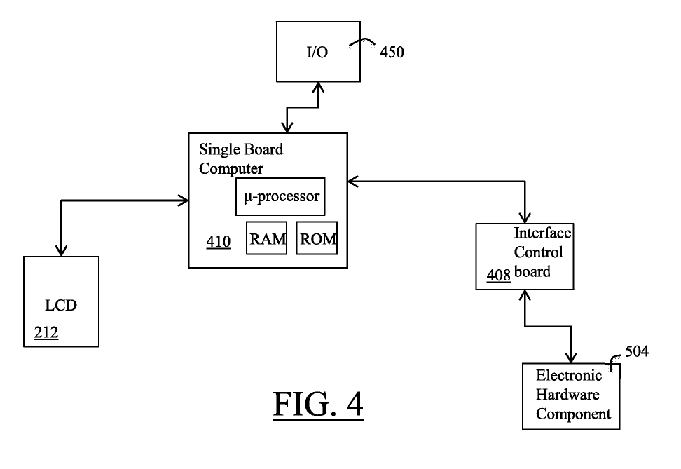

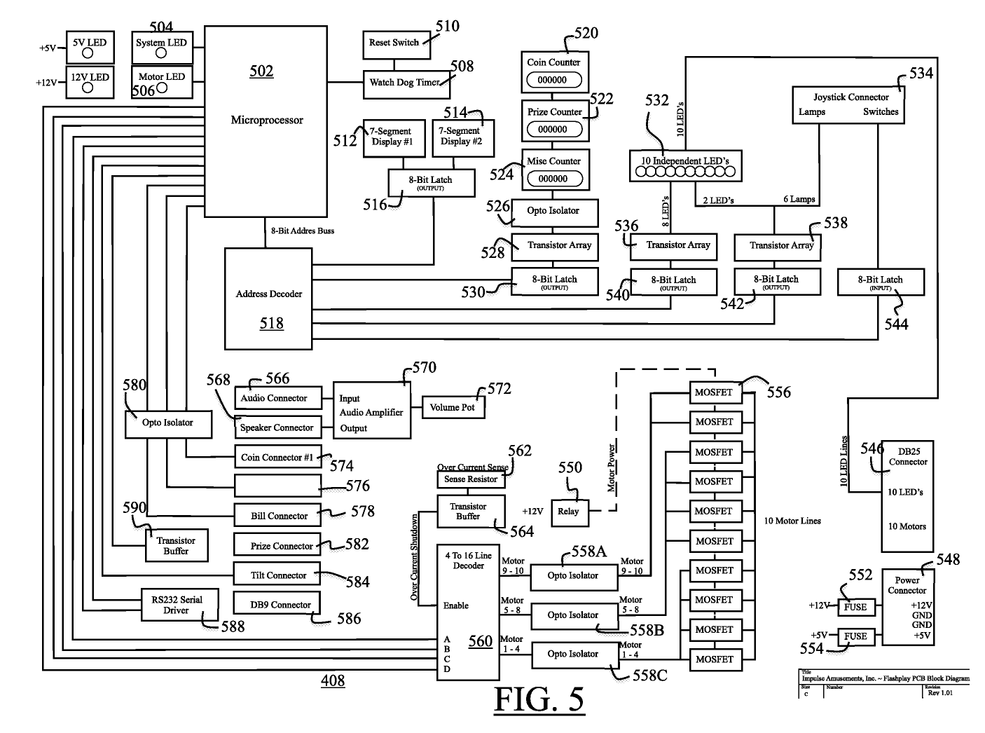

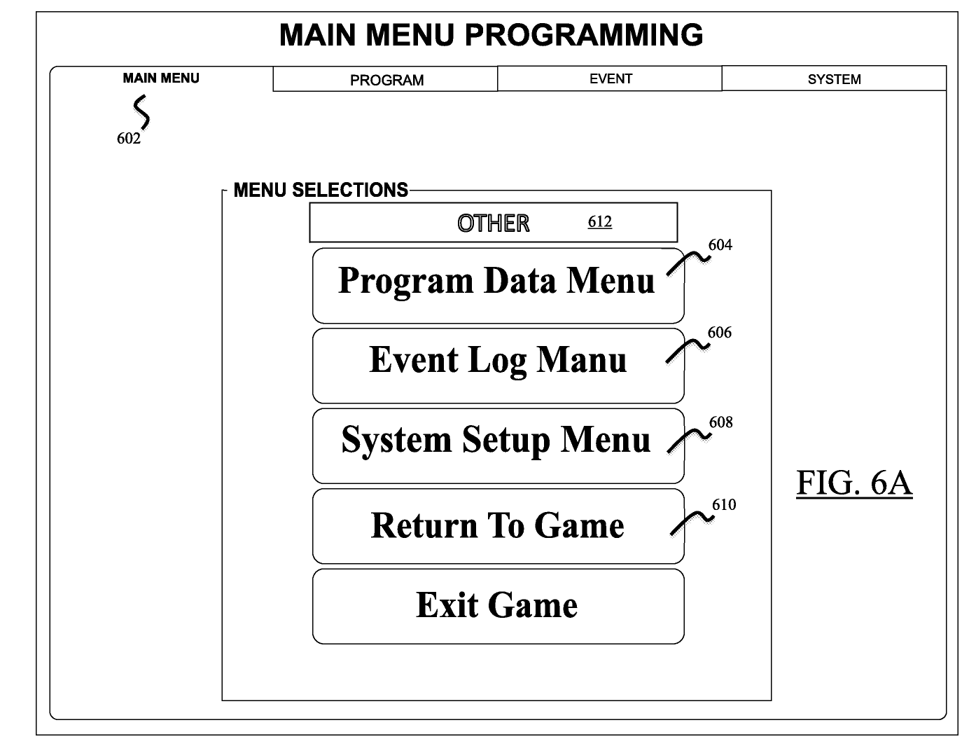

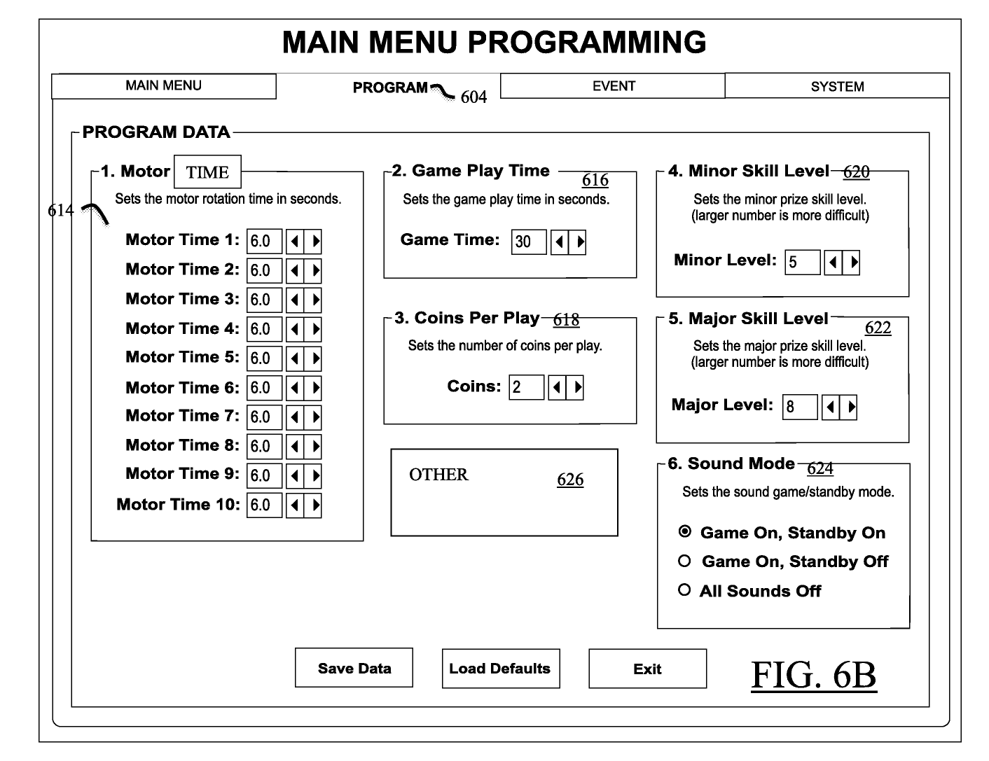

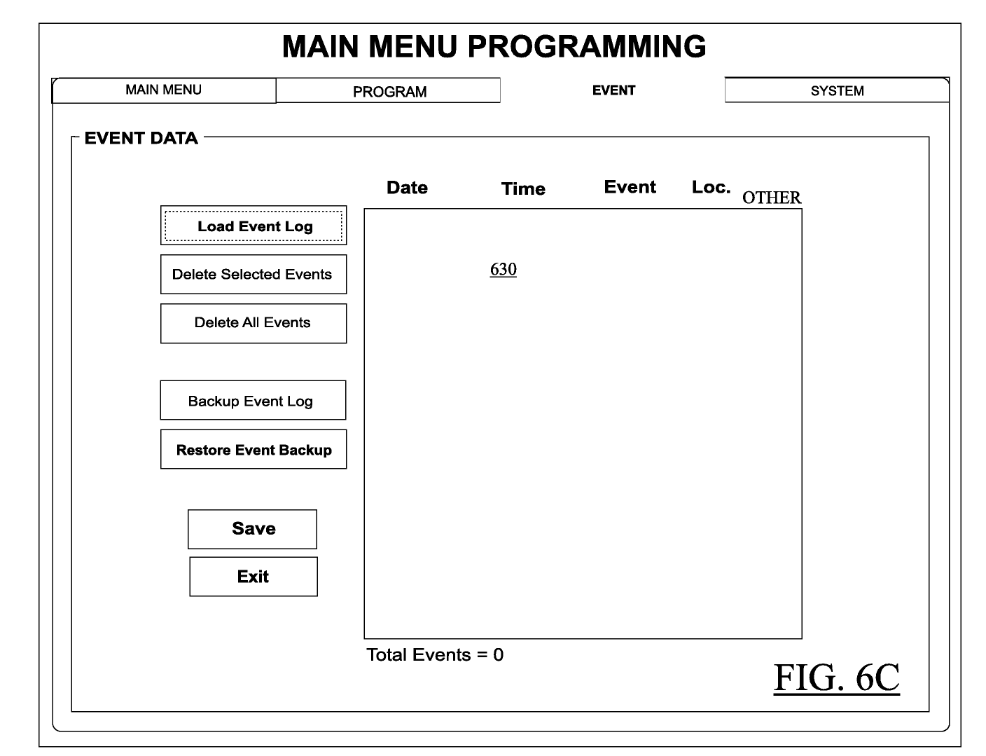

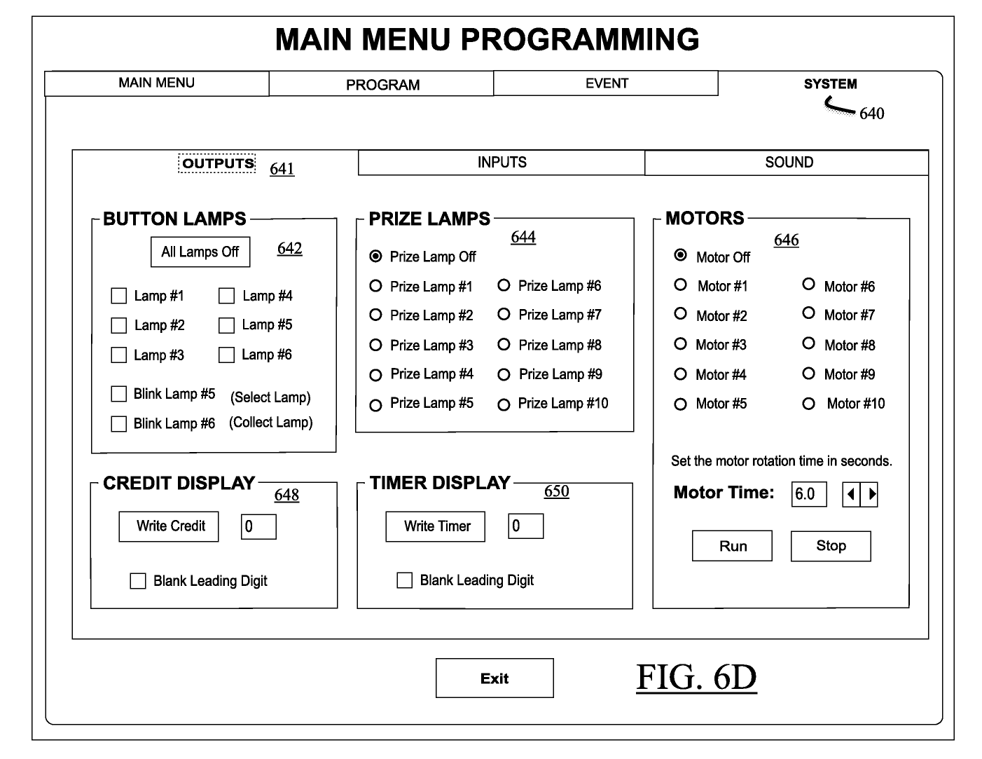

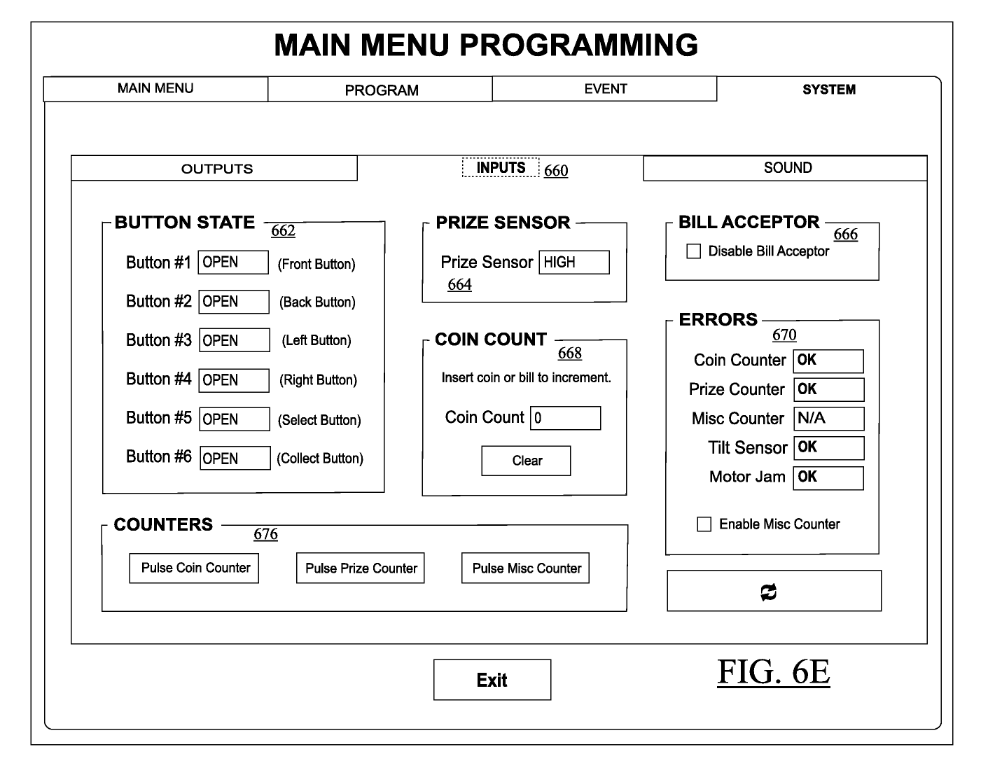

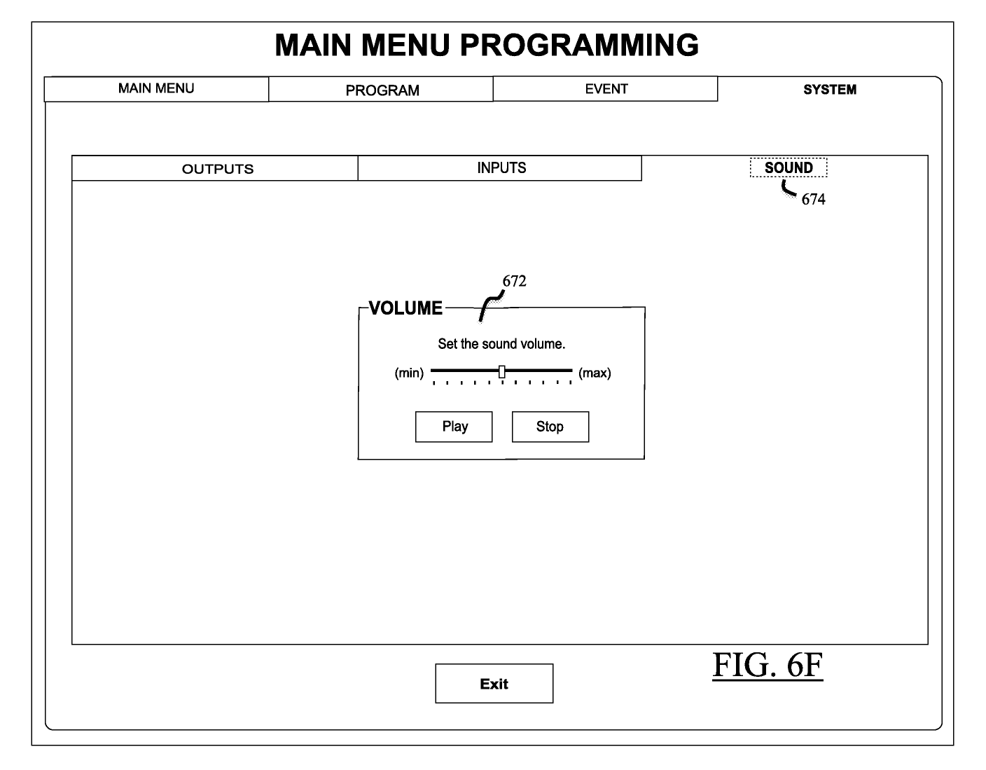

FIG. 4 is an exemplary systems overview block diagram of the amusement gaming machine 200 of the present invention, some of the details of which are further illustrated in FIGS. 5, and 6A to 6F. As illustrated, amusement gaming system of the present invention includes a single board computer 410 that enables and facilitates modularization of the gaming system components of the present invention. Further illustrated is an interface control board 408 that is under the control of and in communication with the single board computer 410, and an electric/hardware system component block (EHC) 504 in communication with the single board computer 410 via the interface control board 408, with the EHC block 504 including the actual electrical hardware such as electric motors, lights, the gaming control console 206, etc. of the amusement gaming system machine 200.

In general, the EHC block 504 may encompass system components that are a permanently fixed part of the machine 200. Non-limiting, non-exhaustive listing of system components that may be included in the electrical / hardware system components block 504 may include the cabinet 202, gaming control console 206, coin and bill acceptors 226 and 228, respectively, dispensers 210, electrical wirings, lights, speakers 406, etc.

The interface control board 408 enables communication between the single board computer 410 and the various electronic and electromechanical hardware included in the EHC block 504, including the display unit. As with electrical components in EHC block 504, the interface control board 408 will not change if the game is changed. Accordingly, any piece of hardware that is not required to be changed and is a permanent part of the amusement gaming system of the present invention, and which requires processing of signals (input, output, power, etc.) for operation, may be controlled by the interface control board 408 (which itself is under the control of the single board computer 410). In other words, the interface control board 408 facilitates signal processing for various gaming system components between the single board computer 410 and other electrical components that are modularized as a permanent part of the system. None limiting, non-exhaustive listing of examples of such gaming system components may include, for example, the dispensers and their associated drives and power lines, the user gaming control panel that includes various user input devices such as buttons, joysticks, etc., all of which require operational and power signals. This separation of functionality between the illustrated blocks enables modularization of the system, which enables easy change of game system without changing hardware.

The interface control board 408 manages input and output signals for control of electric hardware included in EHC block 504 via execution of firmware under the control of the single board computer 410. Stated otherwise, the interface control board 408 is hardware that directly communicates with other hardware, but under the commands of the single board computer 410. The interface control board 408 includes a microprocessor with firmware installed to enable the interface control board 408 to interpret hardware input commands (e.g., when actuating the button 218 on the gaming control console 206) for the single board computer 410, or interpret single board computer 410 input commands (FIGS. 7A to 7F) into hardware output commands (e.g., actuation of a dispenser 210 or turning ON a set of lights under the control of the single board commuter 410).

The entire interface control board 408 is programmed and controlled through the single board computer 410. There is no longer a need to modify any chip (remove it or replace it), as was done in the conventional systems. The interface control board 408 of the present invention is an analog board, under full control of the single board computer 410. In another words, anything or function that can be modified, that modification has been shifted to the single board computer 410. Therefore, any feature that needs to be changed (e.g., how fast or how much a dispenser rotates, for example), is shifted to the single board computer 410 with a conventional operating system similar to computers, non-limiting examples of which may include those used in Personal Computers (PCs).

Accordingly, the interface control board 408 may be thought of as a specialized board that comes between the single board computer 410 and the gaming system component hardware (lights, dispensers, etc.) within the electric hardware component 504, enabling the modification of the gaming system components by the single board computer 410 without modifying the hardware of the interface control board 408. This eliminates the need for changing hardware (e.g., an EEPROM chip or the microprocessor on the interface control board 408) just to modify a function in relation to a gaming system component (e.g., modifying dispenser functionality).

The interface control board 408 enables the single board computer 410 to communicate with external gaming system components hardware (in EHC block 504, e.g., gaming control console 206 that may include buttons, Joystick, etc., and or dispensers, lights, etc.). That is, it translates mechanical motion into electrical digital signals (due to a switch closure for example), which, in turn, is interpreted by the microprocessor on the interface control board (e.g., orientation of the Joystick), and outputted to the single board computer 410 for processing into a move of a character on the LCD display. It should be noted that both EHC block 504 and the interface control board 408 include sufficient input/output mechanisms to accommodate a variety of input and output devices, without requiring changes in the hardware for every game. For example, the EHC bock 504 may include at least two buttons and a joystick on the gaming control console 206 to accommodate games that require all or only one such input device. The interface control board 408 includes electronics (e.g., switches) that facilitates communication with all such input devices on the gaming control console 206. The firmware required to interpret signals from the interface control board 408 into a language that is understood by the single board computer 410 is well known and, in fact, free to be downloaded. Non-limiting example of such a firmware may be downloaded from http://www.1space.nildram.co.uk/freeware.html.

FIG. 5 is an exemplary block illustration of the interface control board 408 in accordance with the present invention. The interface control board 408 functions to translate signals from EHC block 504 (e.g., external hardware such as dispensers, lights, etc.) and communicate the signals to the single board computer 410. The interface control board 408 also functions to control the EHC block 504 under the command of the single board computer 410.

As illustrated in FIG. 5, the interface control board 408 includes a conventional microprocessor 502 that includes firmware in its internal memory for communication and processing of signals. As illustrated, the microprocessor 502 is coupled with various system 504 and motor 506 lights (LEDs) that indicate to a user that the microprocessor 502 and motors (when any one motor is active) are functioning properly. The interface control board 408 further includes a well-known watchdog timer 508 and a reset switch 510, the functionality of both of which is well known. As is well known, the purpose of the watch dog timer 508 is to assure that the microprocessor 502 does not “lock-up” or “freeze,” but continues operations by clocking in the next line of code for execution.

As further illustrated in FIG. 5, the interface control board 408 is coupled with two 7-segment displays 512 and 514 that function as the display 216 on the gaming control console 206. The display 512 informs the player the number of credits the player has for the game, and the display 514 informs the player regarding the amount of time allotted (and remaining) for a game. The 8-bit latch 516 is a well known IC used to minimize the wiring to the displays 512 and 514. The Address decoder 518 coupled with the microprocessor 502 is also a well-known device used as mere port expander.

The interface control board 408 is also coupled with various counters such as a coin counter 520, prize counter 522, and a miscellaneous counter 524, which are non-resettable, electromechanical devices that are hardwired to the microprocessor 502. The counters are designed to meter their respective activities, such as total number of coins counted or total number of prizes counted. The miscellaneous counter 524 is provided for future expansion and may be used to meter other activity. The interface control board 408 uses well-known conventional opto-isolators ICs such as the opto-isolator 526 to transfer or transmit electrical signals using light waves to provide coupling between its input and output (with electrical isolation). The main purpose of an opto-isolator is to isolate and prevent high voltage or rapidly changing voltages or electrical noise on one side of the circuit from damaging components or distorting transmissions on the other side. The counters 520, 522, and 524 have electromagnets that generate electrical noise (Electromagnetic Interference—EMI) that must be isolated from the rest of the components on the interface control board 408. The transistor arrays 528 (which are driven by the 8-bit latch 530) drive the opto-isolator 526.

As further illustrated, the interface control board 408 further communicates with a set of LEDs 532 associated with dispensers 210, and lamps, switches, and joystick 534 associated with the gaming control console 206 via a set of transistor arrays 536 and 538 (under the control of 8-bit latches 540, 542, and 544). It should be noted that the number and types of buttons 218, joystick, lamps (associated with the buttons 218), and switches can easily be varied.

As further illustrated, the interface control board 408 further communicates with the LEDs 532 and the motors (not shown) via a well-known conventional DB25 connector 546. The power connector 548 provides different levels of voltage commensurate with component power requirements. For example, 12V is provided to the motors (not shown) and relay 550 and 5V is provided to various ICs. The power connector 548 includes fuses 552 and 554 for protection and safety. As further illustrated, the interface control board 408 includes a set of Metal Oxide Semiconductor Field Effect Transistors (MOSFETs) 556 that are used to actuate and drive the motors. The relay 550 controls only one of ten MOSFETs 556 at any one time. The relay 550 functions to provide the required high powered switching. Due to electromagnetic interference (EMI) from the motors, various opto-isolators 558A, 558B, and 558C are used to isolate motors from the rest of the circuit of the board 408, including the decoder 560.

As further illustrated, the interface control board 408 further uses a well known 4-to-16 line decoder that functions to enable the microprocessor 502 to have the ability to have more control line. The interface control board 408 further includes over current sensor resistor 562 and a transistor 564 shut-down circuit in case over current is detected due to malfunction of one of the MOSFETs 556.

The interface control board 408 further includes an audio connector 566 in communication with the single board computer 410, which enables communication and control of speakers 406 via an audio amplifier 570 and volume potentiometer 572. In other words, the audio amplifier 570 receives audio signals from the single board computer 410 via the audio connector 566, amplifies and then transmits the amplified audio signal to the speakers 406 via the speaker connector 568. The volume potentiometer 572 is mounted on the cabinet 202 to allow users to lower or increase the game sound.

The interface control board 408 further provides coin connectors 574, 576, and a bill connector 578 that connect to the respective coin and bill acceptor mechanisms 226 and 228. The connectors 574, 576, and 578 enable the microprocessor 502 to read in switching signals from the electromechanical human interface devices such as the coin and bill acceptors 226 and 228 (via the opto-isolator 580), and process those signals accordingly. As further illustrated, a prize connector 582 is provided, which connects to an infrared LED sensing mechanism that when a prize is dropped through the prize shoot 412, the sensing mechanism detects the motion and communicates the sensed information with the microprocessor 502 via the prize connector 582 and its associated transistor buffer 590. The interface control board 408 further provides a tilt sensor connector 584 that connects to a tilt sensor to detect any tilting motion of the amusement gaming machine 200. The interface control board 408 also provides a DB9 connector 586 that enables the board 408 to be coupled with the single board computer 410 so that the microprocessor 502 on the board 408 is able to communicate with the single board computer 410 via the well-known RS232 serial driver 588. Accordingly, the main through port from the single board computer 410 to the interface control board 408 is through the serial communication scheme disclosed.

The interface control board 408 ultimately transmits “keyboard commands” to the single board computer 410, which are the only types of commands that are recognized by most of today's computers. For example, when a player actuates the button 218 on the gaming control console 206, that closes a switch (block 534), which closure is translated or converted by the interface control board 408 into a “keyboard command” or signal recognized by the SBC 410. The actual translation of signals is accomplished by a well-known firmware inside the microprocessor 502. The firmware in fact is available for free download, a non-limiting example of which has been mentioned above. The microprocessor 502 executes the firmware to read/write signals to interface control board 408 and adjoining hardware, including the SBC 410. The firmware interprets mechanical movement (such as a closure of an electrical switch due to actuation or motion of a joystick), into digital signals for processing by the SBC 410 or commands from SBC 410 into mechanical motion of a device (e.g., rotation of a motor). It should be noted that the SBC 410 is a well known off-the-shelf product, a non-limiting example of which may include the Intel Desktop Board D945GSEJT by Intel Corporation, the technical disclosure of which is incorporated by reference herein and readily accessible online in PDF format.

FIGS. 6A to 6F are exemplary Graphic User Interface (GUI) screen shots of software based control panel, which is a gaming systems configuration of settings that is included in the software package purchased by users and is stored within the SBC 410 to enable software based control of the various gaming system components, including the game itself via the interface control board 408. When the game and the gaming system configuration software panel are initially installed, the game automatically starts in the normal mode with the settings of the gaming system configuration software panel set at factory default settings. Thereafter, once the settings are configured as desired, the game starts in the normal mode with the user configured and modified settings. The gaming systems configuration settings software includes a universal set of controls that enable setting of different variables commensurate with game requirements.

The SBC 410 includes a well-known input device such as a mouse that enables users to interact with configuration settings GUI to adjust various gaming system components. Configuration settings GUI also enable users (an administer) to test various gaming system components. For example, the user may test a particular motor that runs a dispense or actuate a light associated with a dispenser, and so on. Therefore, the commands are sent from SBC 410 to the interface control board 408 and the interface control board 408 using various electrical and electronic switching schemes controls and actuates the motors, lights, and other I/O devices via the commands from the configuration settings GUI. Accordingly, users may vary input signals from various input devices (e.g., joystick, buttons, etc.) and control output signals to output devices such as the video monitor, the game itself, the audio and lighting systems, the prize dispensers (that are electromechanical devices using motors), read-in the bill-accepter, read-in the coin mechanism, and output signals for communication of information with computer, etc.

FIG. 6A is a non-limiting, exemplary Graphic User Interface (GUI) screen shot of a main menu selection screen of the software based control panel for configuration of settings. The main menu section screen 602 enables users to access to program data menu 604, event log menu 606, system setup menu 608, return to game 610, and others 612. Accessing the gaming system configuration panel of FIG. 6A is similar to accessing the bios of an operating system, where a user forces the software out of the normal mode and into the non-limiting exemplary screen shown in FIG. 6A by an input command such as holding the F1 key (or in this non-limiting exemplary instance, pressing the right-mouse button three times). This enables the machine 200 to be turned ON and OFF without having to reset or see the setting screen of FIG. 6A, and the game would simply be booted up into normal mode ready for play (similar to the operating system of computer).

FIG. 6B is a non-limiting, exemplary Graphic User Interface (GUI) screen shot of a program data menu selection screen 604 of the software based control panel for configuration of settings. As illustrated, the program data menu 604 enables the user to set the operating duration or time 614 of the various motors. For example, duration of operation for motor 4 may be set for 6 seconds, which means that when the motor 4 operates, it will run for only six seconds and then stop. As described above, the dispensers 210 are coupled with motors that actuate the dispensers to dispense a prize. The amount of time that the dispenser is actuated is controlled by program data menu 604. This control is important in that if there is a malfunction with the motor, where the motor continuously operates, setting the time to a particular time limit stops motor operation after the maximum time limit set. For example, a dispenser may hold five or six prizes, and if its motor malfunctions and continually operates without stop, it will dispense all prizes. Accordingly, when setting the maximum operating time limit, the motors will stop actuation of the dispensers. Another reason to control the duration of the operation of the motors of the dispensers is that it enables accommodating of dispensing of different sized prizes. For example, dispenser 3 associated with motor 3 may hold large sized prizes requiring a longer time to be dispensed, which means a longer operational time of the motor 3, whereas dispense 7 may have smaller sized prizes (enabling more of the same prize to be held by the dispenser), requiring a shorter time of operation for dispensing the smaller prizes. Size of the prize will determine how many of the prize can fit on a dispenser.

The game play time module 616 sets the duration of the game, the results of which are shown in the display 216 of the gaming control console 206 via the interface control board 408 (one of the 7-segment display 512 or 514). The gaming play time module 616 is an example of one control module where both hardware and software are controlled, with the hardware the display 216 and the software the duration of the software game itself. For example, the user may wish to set each game to have duration of no more than 30 seconds or 60 seconds.

The coins per play module 618 sets the number of coins required per play, which is in communication both hardware devices (e.g., coin acceptors, coin counter, microprocessor 502, and one of the 7-segment displays as the display 216 on the gaming control console 206), and software game itself on the SBC 410 where once a full credit is earned (displayed on 216), the software game beings to play. A credit is equal to the number of coins required to commence a game. For example, if the game requires 2 coins (e.g., two 25 cents, for a total of 50 cents), then once two coins are received, a full credit for a single game is displayed on 216. It should be noted that the coins per play is nondenominational. That is, the coins per play module 618 does not account if the coins are in Euro's or U.S. dollars or cents, which enables the machine 200 of the present invention to be used in countries outside the U.S. As further illustrated, skill level setting modules 620 and 622 enable the user (administrators) to set skill or difficulty levels for winning different classes of prizes (e.g., a major, minor, and medium prizes). The difficulty setting depends on the game, which may be speed, human reaction time, or some other criteria. The sound mode module 624 enables full control of the audio sounds (music, etc.) associated with the game. Game ON, Standby ON means that the game is ON (displayed) and sound or audio music associated with the game is ON. This might be appropriate in an arcade where a sample game with full sound effect is played over and over. The Game ON, Standby OFF means that the game is ON (displayed) but the audio music associated with the game is OFF. The Others module 626 may be used for additional, more granulated control of the various aspects of the machine 200.

The firmware used with most conventional amusement gaming system are very rudimentary, and substantially lack sufficient sophistication to provide data and information that might be vital to the owner to improve revenue. For example, most conventional firmware lack the ability to indicate the time, date, and the particular location (e.g., the specific prize dispenser that held a prize) for a specific winning, in particular, a prize of substantial value to the owner. Such information enables the owner to determine if the prize no longer within the machine was won or stolen. The prior art has rudimentary means to provide data with respect to very specific error (e.g., the prize dispenser #2 rotated too much). However, no information is provided with respect to time, day, and dispenser number with respect to a legitimate winning or malfunction. This lack of information is problematic because the owner of the machine cannot determine whether the prize was won through skill (legitimately), or whether the prize was lost (or dispensed via a prize dispenser) through malfunction. Therefore, the conventional software lacks providing data and information with respect to proper winning The conventional software further lacks granulated information required to provide a statistical data that might be of use to the owner. The conventional software lacks the sophistication to provide a snap shot of a particularly time period (or granulated statistical data with respect to location, time, date, etc.) within which revenue was generated. The event log menu 630 of FIG. 6C logs various events associated with the machine 200 of the present invention, including the date, time, and the specific winning (event and location—the specific dispenser from which the prize was dispensed), including other granulated information that fully informs the owner about specific winnings so that the owner can make an informed decision to maximize profits.

As illustrated in FIG. 6D to 6F, the system setup menu 640 enables users to test output devices via various programming output modules 641 such as button lamps 642, prize lamps 644, motors 646, and other displays, including credit display module 648 (for the credit display 216), timer display module 650 (also in 216), and more. As best illustrated in FIGS. 6E and 6F, input devices via various programming input modules 660 such as button state module 662 (e.g., is a button pressed, and if so, is there a single indicating the closure of a switch associated with the button), prize sensors module 664 (their sensitivity and if they sense a prize falling through the prize shut), bill acceptor module 666, coin counter module 668, and error checking module 670 and so on can also be tested and set, including volume control module 672 via the sound tab 674, which is illustrated in FIG. 6F. As best illustrated in FIG. 6E, the present invention further provides redundant, backup mechanical counters module 676, which are mechanical counters used to keep track of counts that are also tracked in software such as the software based counters 664, 666, and 668.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. For example, different types of masks and shapes thereof may be used for different games. All electronics may easily be upgraded for advanced capabilities, such as an upgraded microprocessor or motherboard. The shape and sizes of the cabinets may be varied, including placements of the marquees. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

In addition, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of,” “act of,” “operation of,” or “operational act of” in the claims herein is not intended to invoke the provisions of 35 U.S.C. 112, Paragraph 6.

What is claimed is:

1. A video amusement gaming system that rewards players with prizes, comprising:
electric and electronic hardware components;
a computer system;
a monitor for display of a game;
control panel to configure settings for the amusement gaming system;
an interface control board that enables communications of a first set of signals associated with the control panel with the computer system and a second set of signals associated with electric and electronic hardware components.

2. A video amusement gaming system that rewards players with prizes, comprising:
a cabinet that houses the video amusement gaming system, including electric and electronic hardware components;
a monitor;
a single board computer system with associated input and output devices for installing a game for display on the monitor and configuring control signals associated with the game; and
an interface control board that communicates a first set of signals associated with the single board computer systems with electric and electronic hardware components that are associated with a second set of signals.

3. A video amusement gaming system that rewards players with prizes, comprising:
an enclosed cabinet with a single ingress and egress access into and out of an interior of the cabinet, having a fully, permanently closed back wall and a single door that opens from a front of the cabinet that has a height substantially commensurate with a height of the cabinet to enable secure access for easy installation, repair, and maintenance of system components in the interior of the cabinet;
theme accommodating structures associated with the cabinet to detachably house interchangeable and exchangeable removable themes associated with a particular game;
inconspicuous daisy chained wiring system that daisy chains all electrical system components together by an electrical wire that provides power and control signals to system components, and is accessible from a front interior of the cabinet;
electric and electronic hardware components;
a monitor;
a single board computer system with associated input and output devices for installing the game and associated control signals;
an interface control board that communicates a first set of signals associated with the single board computer systems with electric and electronic hardware components that are associated with a second set of signals.

4. The video amusement gaming system that rewards players with prizes as set forth in claim 3, wherein:
the monitor is covered by an overlay mask for providing context for and meaning to a game, including providing simulation of Light Emitting Diode based gaming system.

5. A computer program product for a video amusement gaming system, the computer program product comprising a computer-readable medium having computer program instructions stored therein for causing one or more computers to perform operations of:
providing user interface control panel on a display screen to configure settings for the amusement gaming system, including:
a first control panel that includes:
modules for setting motor actuation states, skill level states, game play time, and required coins per play;
a second control panel that includes:
output setting modules for setting states of output devices; and
input setting module for setting and determining actuation of input devices;
an event log module that determines time, day, and dispenser number with respect to a legitimate winning or malfunction.
